(19) United States
(12) Patent Application Publication
(10) Pub. No.: US 2020/0125235 A1
(43) Pub. Date: Apr. 23, 2020

(54) Adjustable Virtual User Input Devices To Accommodate User Physical Limitations

(71) Applicant: Microsoft Technology Licensing, LLC, Redmond, WA (US)

(72) Inventors: Joshua Benjamin EITEN, Seattle, WA (US); Dong Back KIM, Bellevue, WA (US); Ricardo Acosta MORENO, Vancouver (CA)

(21) Appl. No.: 16/459,451

(22) Filed: Jul. 1, 2019

Related U.S. Application Data
(63) Continuation-in-part of application No. 16/168,800, filed on Oct. 23, 2018.

(51) Int. Cl. G06F 3/0481; G06F 3/01

(52) U.S. Cl. CPC G06F 3/04815; G06F 3/011

(57) ABSTRACT

The construction of virtual-reality environments is more efficient with adjustable virtual user input devices that accommodate user physical limitations. Adjustable virtual user input devices can be adjusted along pre-established channels, which can be anchored to specific points in virtual space, including a user's position. Adjustable virtual user input devices can be bent in a vertical direction, bent along a horizontal plane, or other like bending, skewing, or warping adjustments. Elements, such as individual keys of a virtual keyboard, can be anchored to specific points on a host virtual user input device, such as the virtual keyboard itself, and can be bent, skewed, or warped in accordance with the adjustment being made to the host virtual user input device. The adjustability of virtual user input devices can be controlled through handles, which can be positioned to appear as if they are protruding from designated extremities of virtual user input devices.

### CROSS-REFERENCE TO RELATED APPLICATIONS

This application claims the benefit of and priority to U.S. patent application Ser. No. 16/168,800 filed on Oct. 23, 2018 and entitled “Efficiency Enhancements To Construction Of Virtual-reality Environments”, which application is expressly incorporated herein by reference in its entirety.

### BACKGROUND

Because of the ubiquity of the hardware for generating them, two-dimensional graphical user interfaces for computing devices are commonplace. By contrast, three-dimensional graphical user interfaces, such as virtual-reality, augmented reality, or mixed reality interfaces are more specialized because they were developed within specific contexts where the expense of the hardware, necessary for generating such three-dimensional graphical user interfaces, was justified or invested. Accordingly, mechanisms for constructing virtual-reality computer graphical environments are typically specialized to a particular application or context, and often lack functionality that can facilitate more efficient construction of virtual-reality environments. Additionally, the fundamental differences between the display of two-dimensional graphical user interfaces, such as on traditional, standalone computer monitors, and the display of three-dimensional graphical user interfaces, such as through virtual-reality headsets, as well as the fundamental differences between the interaction with two-dimensional graphical user interfaces and three-dimensional graphical user interfaces, render the construction of three-dimensional virtual-reality environments unable to benefit, in the same manner, from tools and techniques applicable only to two-dimensional interfaces.

### SUMMARY

The construction of virtual-reality environments can be made more efficient with adjustable virtual user input devices that can accommodate user physical limitations. Such adjustable virtual user input devices can include the user interface elements utilized to create virtual-reality environments, as well as the user interface elements that will subsequently be utilized within the created virtual-reality environments. Adjustable virtual user input devices can be adjusted along pre-established channels, with adjustments beyond such pre-established channels being snapped-back onto the pre-established channel. Such pre-established channels can be anchored to specific points in virtual space, including being based on a user position. Even without such channels, the adjustability of the virtual user input devices can be based upon specific points in the virtual space, such as points based on a user's position. Adjustable virtual user input devices can be bent in a vertical direction, bent along a horizontal plane, or other like bending, skewing, or warping adjustments. Elements, such as individual keys of a virtual keyboard, can be anchored to specific points on a host virtual user input device, such as the virtual keyboard itself, and can be bent, skewed, or warped in accordance with the adjustment being made to the host virtual user input device. The adjustability of virtual user input devices can be controlled through handles, or other like user-interactable objects, which can be positioned to appear as if they are protruding from designated extremities of virtual user input devices. Such handles can be visible throughout a user's interaction with the virtual-reality environment, or can be presented only in response to specific input indicative of a user's intent to adjust a virtual user input device. Such input can include user action directed to a specific portion of the virtual user input device, user attention directed to the virtual user input device for greater than a threshold amount of time, or other like user actions. Additionally, virtual user input devices can move, or be repositioned, to remain at a maximum angle to the side of a user facing direction. Such a repositioning can be triggered by a user exceeding a turn angle threshold.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIGS. 1a and 1b are system diagrams of an exemplary adjustable virtual user input device;

FIGS. 2a and 2b are system diagrams of another exemplary adjustable virtual user input device;

FIG. 3 is a system diagram of an exemplary establishment of adjustability limitations for adjustable virtual user input devices;

FIG. 4 is a system diagram of an exemplary enhancement directed to the exchange of objects between multiple virtual-reality environments;

FIG. 5 is a system diagram of an exemplary enhancement directed to the conceptualization of the virtual-reality environment as perceived through different types of three-dimensional presentational hardware;

FIGS. 6a and 6b are system diagrams of an exemplary enhancement directed to the sizing of objects in virtual-reality environments; and

FIG. 7 is a block diagram of an exemplary computing device.

### DETAILED DESCRIPTION

The following description relates to the adjustability of virtual user interface elements, presented within a virtual-reality, three-dimensional computer-generated context, that render the construction of, and interaction with, virtual-reality environments physically more comfortable and more accommodating of user physical limitations. Such adjustable virtual user input devices can include the user interface elements utilized to create virtual-reality environments, as well as the user interface elements that will subsequently be utilized within the created virtual-reality environments. Adjustable virtual user input devices can be adjusted along pre-established channels, with adjustments beyond such pre-established channels being snapped-back onto the pre-established channel. Such pre-established channels can be anchored to specific points in virtual space, including being based on a user position. Even without such channels, the adjustability of the virtual user input devices can be based upon specific points in the virtual space, such as points based on a user's position. Adjustable virtual user input devices can be bent in a vertical direction, bent along a horizontal plane, or other like bending, skewing, or warping adjustments. Elements, such as individual keys of a virtual keyboard, can be anchored to specific points on a host virtual user input device, such as the virtual keyboard itself, and can be bent, skewed, or warped in accordance with the adjustment being made to the host virtual user input device. The adjustability of virtual user input devices can be controlled through handles, or other like user-interactable objects, which can be positioned to appear as if they are protruding from designated extremities of virtual user input devices. Such handles can be visible throughout a user's interaction with the virtual-reality environment, or can be presented only in response to specific input indicative of a user's intent to adjust a virtual user input device. Such input can include user action directed to a specific portion of the virtual user input device, user attention directed to the virtual user input device for greater than a threshold amount of time, or other like user actions. Additionally, virtual user input devices can move, or be repositioned, to remain at a maximum angle to the side of a user facing direction. Such a repositioning can be triggered by a user exceeding a turn angle threshold.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including servers, hand-held devices, multi-processor systems, microprocessor based or programmable consumer electronics, network PCs, minicomputers, mainframe computers, and the like. Similarly, the computing devices need not be limited to stand-alone computing devices, as the mechanisms may also be practiced in distributed computing environments where tasks are performed by remote processing devices that are linked through a communications network. In a distributed computing environment, program modules may be located in both local and remote memory storage devices.

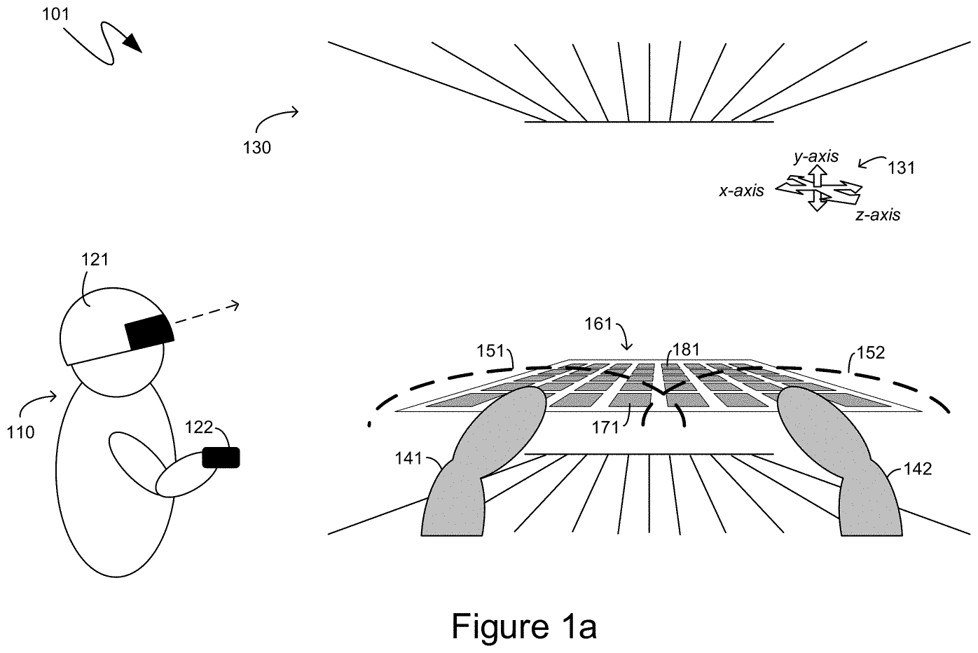

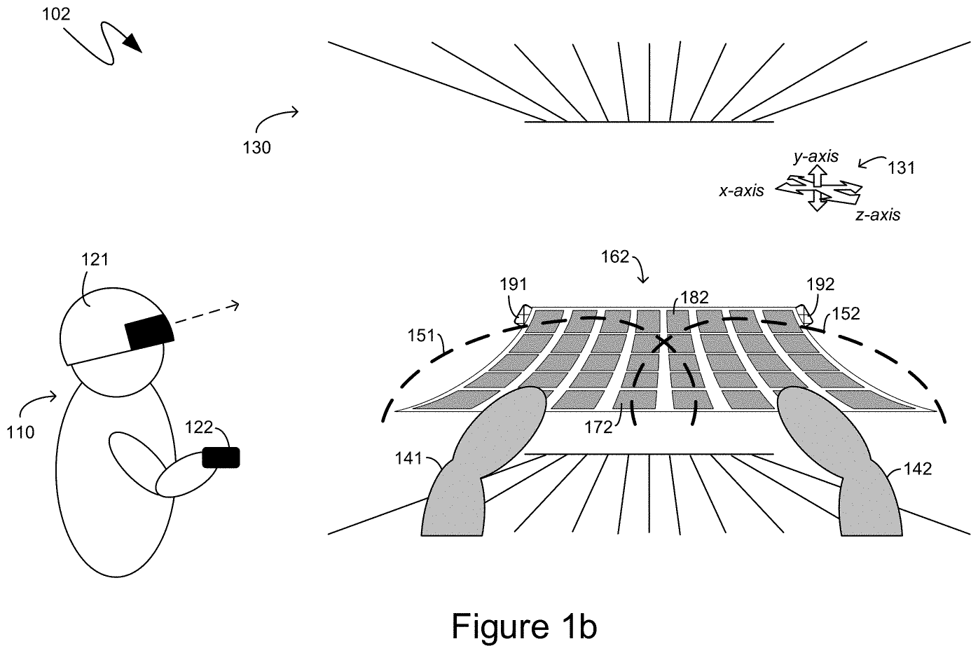

With reference to FIG. 1a, an exemplary system 101 is illustrated, comprising a virtual-reality interface 130, such as could be displayed to a user 110 on a virtual-reality display device, such as the exemplary virtual-reality headset 121. The user 110 can then interact with the virtual-reality interface 130 through one or more controllers, such as an exemplary hand-operated controller 122. As utilized herein, the term “virtual-reality” includes “mixed reality” and “augmented reality” to the extent that the differences between “virtual-reality”, “mixed reality” and “augmented reality” are orthogonal, or non-impactful, to the mechanisms described herein. Thus, while the exemplary interface 130 is referred to as a “virtual-reality” interface, it can equally be a “mixed reality” or “augmented reality” interface in that none of the mechanisms described require the absence of, or inability to see, the physical world. Similarly, while the display device 121 is referred to as a “virtual-reality headset”, it can equally be a “mixed reality” or “augmented reality” headset in that none of the mechanisms described require any hardware elements that are strictly unique to “virtual-reality” headsets, as opposed to “mixed reality” or “augmented reality” headsets. Additionally, references below to “virtual-reality environments” or “three-dimensional environments” or “worlds” are meant to include “mixed reality environments” and “augmented reality environments”. For simplicity of presentation, however, the term “virtual-reality” will be utilized to cover all such “virtual-reality”, “mixed reality”, “augmented reality” or other like partially or wholly computer-generated realities.

The exemplary virtual-reality interface 131 is illustrated as it would be perceived by the user 110, such as through the virtual-reality display device 121, with the exception, of course, that FIG. 1a is a two-dimensional illustration, while the virtual-reality display device 121 would display the virtual-reality interface 131, to the user 110, as a three-dimensional environment. In illustrating a three-dimensional presentation on a two-dimensional medium, some of the Figures of the present application are shown in perspective, with a compass 139 illustrating the orientation of the three dimensions within the perspective of the two-dimensional drawing. Thus, for example, the compass 139 shows that the perspective of the virtual-reality interface 131, as drawn in FIG. 1a, is oriented such that one axis is vertically aligned along the page, another axis is horizontally aligned along the page, and the third axis is illustrated in perspective to simulate the visual appearance of the third access being orthogonal to the page and extending from the page towards, and away from, the viewer.

The exemplary virtual-reality interface 131 is illustrated as comprising an exemplary virtual user input device, in the form of the exemplary virtual-reality keyboard 161. The virtual-reality keyboard 161 can comprise multiple elements, such as individual keys of the virtual-reality keyboard, including, for example, the keys 171 and 181. As will be recognized by those skilled in the art, a user, such as the exemplary user 110, can interact with virtual user input devices, such as the exemplary virtual-reality keyboard 161, by actually physically moving the user's hands much in the same way that the user would interact with an actual physical keyboard having a size and shape equivalent to the virtual-reality keyboard 161. Typically, the user's arms 141 and 142 are illustrated in the virtual-reality interface 131, which, can include an image of the user's actual arms, such as in an augmented reality interface, or a virtual rendition of the user's arms, such as in a true virtual-reality interface. In such a manner, the user's moving of their arms is reflected within the exemplary virtual-reality interface 131.

However, because interaction with virtual user input devices, such as the exemplary virtual-reality keyboard 161, is based upon actual physical movements of the user 110, physical user limitations can impact the user's ability to interact with the virtual user input devices. For example, the user's arms may simply not be long enough to reach the extremities of a virtual user input device such as, for example, the exemplary virtual-reality keyboard 161. Within the system 101 shown in FIG. 1a, the extent of the reach of the user's arms 141 and 142 is illustrated by the limits 151 and 152, respectively. Reaching beyond the limits 151 and 152 can require the user to stretch awkwardly, physically move their location, or perform other actions to accommodate the size of the exemplary virtual-reality keyboard 161. Absent such actions, portions of the virtual-reality keyboard 161, such as the key 181, can be beyond the limits 151 and 152 of the user's reach.

Accordingly, according to one aspect, it can be desirable for the user to change the shape of the virtual user input device. In particular, because the virtual user input device is merely a computer-generated image, it can be modified in manipulated in ways that would be impossible or impractical for physical user interface elements. Turning to FIG. 1b, the exemplary system 102 shown in FIG. 1b illustrates an updated version of the virtual-reality interface 131, illustrated previously in FIG. 1a, now being shown as the virtual-reality interface 132.

Within the exemplary virtual-reality interface 132, the virtual user input device, namely the exemplary virtual-reality keyboard 162, is shown as a bent version of the exemplary virtual-reality keyboard 161, that was illustrated previously in FIG. 1a. In particular, the exemplary virtual-reality keyboard 162 is shown as having been bent upward towards the user such that the back of the exemplary virtual-reality keyboard 162, that was furthest from the user in the virtual-reality space of the virtual-reality interface 132, was bent upward and towards the user, and again within the virtual-reality space. As a result, the limits 151 and 152 can cover more of the keys of the virtual-reality keyboard 162, including, for example, the key 182, which can be the key 181, shown previously in FIG. 1a, except now bent in accordance with the bending of the virtual-reality keyboard 162.

A user can provide input to a computing device generating the virtual-reality interface 132, which input can then be utilized to determine an amount by which the exemplary virtual-reality keyboard 162 should be bent. For example, one or more handles, such as exemplary handles 191 and 192 can be displayed on an edge, corner, extremity, or other portion of the virtual-reality keyboard 162, and user interaction with the handles 191 and 192 can determine an amount by which the virtual-reality keyboard 162 should be bent. For example, the user can grab the handles 191 and 192 with their arms 141 and 142, respectively, and can then pull upward and towards the user, causing the portion of the virtual-reality keyboard 162 that is furthest, in virtual-reality space, from the user, and which is proximate to the handles 191 and 192, to be bent upward and towards the user, such as in the manner shown in FIG. 1b.

More specifically, the shape of the bent virtual-reality keyboard 162 can be based on a position of the user's hands, within virtual-reality space, while the user's hands continue to hold onto, or otherwise interface with, the handles 191 and 192. For example, the back-right of the bent virtual-reality keyboard 162, namely the portion of the virtual-reality keyboard 162 that is most proximate to the handle 192, can have its position and orientation determined by a position and orientation of the user's right hand while it continues to interface with the handle 192. Similarly, the back-left of the bent virtual-reality keyboard 162, namely the portion of the virtual-reality keyboard 162 that is most proximate to the handle 191, can have its position and orientation determined by position and orientation of the user's left hand while it continues to interface with the handle 191. The remainder of the back of the virtual-reality keyboard 162, namely the edge of the virtual-reality keyboard 162 that is positioned furthest from the user in virtual-reality space, can be linearly orientated between the position and orientation of the back-right portion, determined as detailed above, and the position and orientation of the back-left portion, also determined as detailed above.

The remainder of the bent virtual-reality keyboard 162, extending towards the user, can be bent in accordance with the positions determined as detailed above, in combination with one or more confines or restraints that can delineate the shape of the remainder of the bent virtual-reality keyboard 162 based upon the positions determined as detailed above. For example, the portion of the virtual-reality keyboard 162 closest to the user in virtual-reality space can have its position, in virtual-reality space, be unchanged due to the bending described above. More generally, a portion of a virtual user input device, opposite the portion of the virtual user input device that is closest to the handles being interacted with by the user to bend the virtual user input device, can be deemed to have its position fixed in virtual-reality space. The remainder of the virtual user input device extending between the portion whose position is fixed in virtual-reality space and the portion whose position is being moved by the user, such as through interaction with handles, can bend, within the virtual-reality space, in accordance with predefined restraints or confines. For example, many virtual-reality environments are constructed based upon simulations of known physical materials or properties. Accordingly, a bendable material that is already simulated within the virtual-reality environment, such as aluminum, can be utilized as a basis for determining a bending of the intermediate portions of the virtual user input device. Alternatively, or in addition, the intermediate portions of virtual user input devices can be bent in accordance with predefined shapes or mathematical delineations. For example the exemplary bent virtual-reality keyboard 162 can be bent such that the bend curve of the keyboard 162, when viewed from the side, follows an elliptical path with the radii of the ellipse being positioned at predefined points, such as points based on the location of the user within the virtual-reality space, the location of the user's hands as they interact with the handles 191 and 192, or other like points in virtual-reality space.

The bending, or other adjustment to the shape of a virtual user input device, can be propagated through to the individual elements of the virtual user input device whose shape is being adjusted. For example, as illustrated in the exemplary system 102, the bending of the keyboard 162 can result in the bending of individual keys of the keyboard 162, such as the exemplary keys 172 and 182.

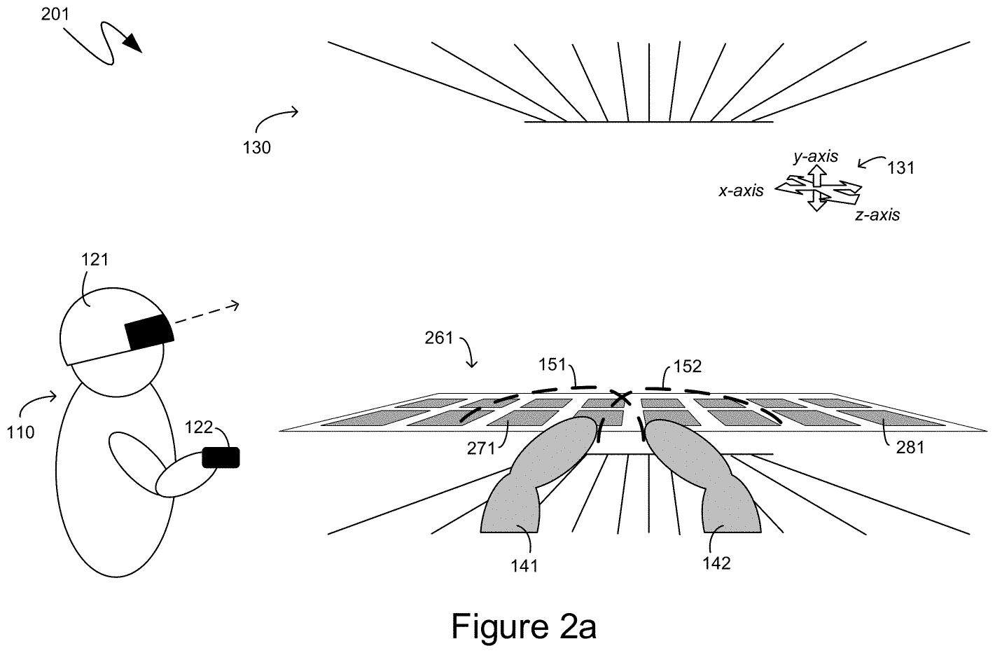

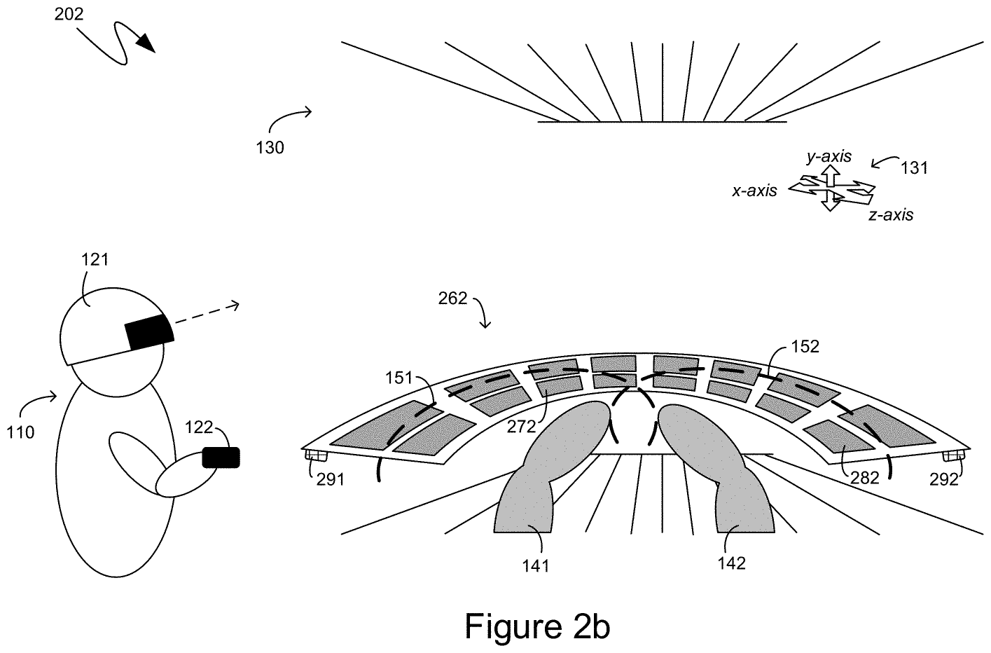

Turning to FIG. 2a, the exemplary system 201 shown therein illustrates another virtual user input device in the form of the exemplary keyboard 261, which can comprise individual sub-elements, such as the keys 271 and 281. As indicated previously, the size, position or orientation of a virtual user input device can be such that the user's physical limitations prevent the user from easily or efficiently interacting with the virtual user input device. For example, in the exemplary system 201, the extent of the reach of the user's arms 141 and 142 is illustrated by the limits 151 and 152, respectively. As can be seen, therefore, the exemplary keyboard 261 can extend to the user's left and right, in virtual space, beyond the limits of 151 and 152. Thus, in the exemplary system 201, the size of the exemplary virtual keyboard 261 can require the user to laterally move each time the user wished to direct action, within the virtual-reality environment, onto the key 281, for example.

According to one aspect, the user can bend the virtual user input device, such as the exemplary virtual keyboard 261, into a shape more accommodating of the user's physical limitations. While the bending described above with reference to FIGS. 1a and 1b may not have involved changing the surface area of a virtual user input device, because virtual user input devices are not physical entities, the bending of such virtual user input devices can include stretching, skewing, or other like bend actions that can increase or decrease the perceived surface area of such virtual user input devices. For example, and turning to FIG. 2b, the exemplary system 202 shown therein illustrates an exemplary bent virtual keyboard 262 which can be bent around the user at least partially. The exemplary bent virtual keyboard 262, for example, can be bent around the user so that the keys of the bent virtual keyboard 262 are within range of the limits 151 and 152, which can define an arc around the user reachable by the user's arms 141 and 142, respectively. Thus, as can be seen, the user can reach both the keys 272 and 282 without needing to reposition themselves, or otherwise move in virtual space.

As detailed above, handles, such as the exemplary handles 291 and 292, can extend from a portion of a virtual user input device, such as in the manner illustrated in FIG. 2b. A user interaction with the handles 291 and 292, such as by grabbing them in the virtual-reality environment and moving the user's arms in virtual space while continuing to hold onto the handles 291 and 292 can cause the virtual user input device to be bent in a manner conforming to the user's arm movements. For example, the system 202 shown in FIG. 2b illustrates an exemplary bent virtual-reality keyboard 262 that can have been bent by the user grabbing the handles 291 and 292 and bending towards the user the extremities of the virtual-reality keyboard 262 that are proximate to the handles 291 and 292. Thus, comparing the bent virtual-reality keyboard 262 with the corresponding, not bent virtual-reality keyboard 261 shown in FIG. 2a, the extremities of the virtual-reality keyboard that are proximate to the handles 291 and 292 can have been bent inward towards the user, from their original position shown in FIG. 2a.

As indicated previously, the remaining portions of a virtual user input device, that are further from the handles that were grabbed by the user, in the virtual-reality environment, can be bent, moved, or otherwise have their position, in virtual space, readjusted based upon the positioning of the user's arms, while still holding onto the handles, and also based upon relevant constraints or interconnections tying such remaining portions of the virtual user input device to the portions of the virtual user input device that are proximate to the handles. For example, while the extremities of the bent virtual-reality keyboard 262 can have been bent inward towards the user, the central sections of the bent virtual-reality keyboard 262 can remain in a fixed location in virtual space. Correspondingly, then, the intermediate portions of the virtual-reality keyboard 262, interposed between the central sections whose position remains fixed, and the extremities that are being bent towards the user, can be bent towards the user by a quantity, or degree, delineated by their respective location between the central, immovable portions, and the extremities was movement is most pronounced. For example, the position, in virtual space, of the user's arms while holding onto the handles 291 and 292 can define a circular or elliptical path having a center based on the user's position in virtual space. The virtual user input device being bent can then be bent such that locations along the virtual user input device are positioned along the circular or elliptical path defined by the position of the user's arms while holding onto the handles 291 and 292 and having a center based on the user's position.

As also indicated previously, individual elements of a virtual user input device, such as the exemplary keys 272 and 282, can be anchored to portions of the host virtual user input device, such as the exemplary bent virtual-reality keyboard 262, such that bending of the virtual-reality keyboard 262 results in the exemplary keys 272 and 282 being bent accordingly in order to remain anchored to their positions on the virtual-reality keyboard 262. Thus, for example, the keys 272 and 282 can be bent along the same circular or elliptical curve as the overall virtual-reality keyboard 262.

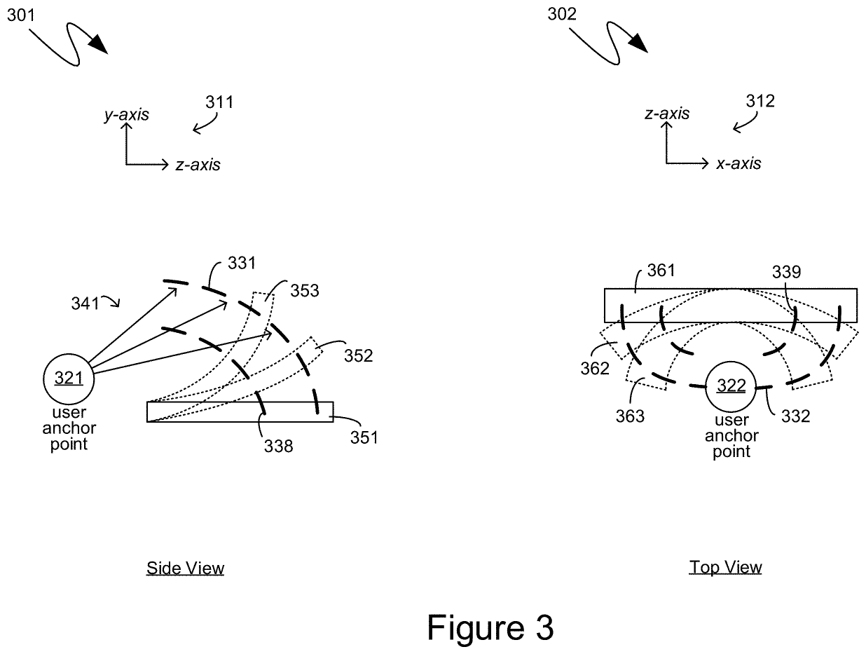

Turning to FIG. 3, the systems 301 and 302 illustrated therein show exemplary predefined paths, channels or other like constraints that can facilitate the bending of virtual user input devices. Turning first to the exemplary system 301, it shows a side view, as illustrated by the compass 311 indicating that while the up and down directions can remain aligned with up and down along the page on which exemplary system 301 is represented, the left and right directions can be indicative of distance away from or closer to a user positioned at the user anchor point 321. An exemplary channel 331 is illustrated based on an ellipse whose radii can be centered around the user anchor point 321, as illustrated by the arrows 341. The exemplary channel 331 can define a bending of a virtual user input device positioned in a manner analogous to that illustrated by the exemplary virtual user input device 351. In particular, the user action, in the virtual-reality environment, directed to the back of the virtual user input device 351, namely the rightmost portion of the virtual user input device 351, as shown in the side view represented by the exemplary system 301, can cause the portions of the virtual user input devices 351 proximate to such user action to be bent upward along the channel 331 if the user moves their arms in approximately that same manner. Thus, for example, if the user were to grab handles of the virtual user input device 351 that were proximate to the back of the virtual user input device 351, as viewed from the user's perspective, and to pull such handles upward and towards the user, the back of the virtual-reality user-interface elements 351 could be bent upward and towards the user along the channel 331. Continued bending by the user could cause the virtual user input device 351 to be bent into version 352 and then subsequently into version 353 as the user continued their bending motion.

Intermediate portions of the virtual user input device 351 can be positioned according to intermediate channels, such as the exemplary channel 338. Thus, an intermediate portion of the virtual user input device 351 can be curved upward in the manner illustrated by the version 352, and can then be further curved upward in the manner illustrated by the version 353 as the user continues their bending of the virtual user input device 351. In such a manner, the entirety of the virtual user input device 351 can be bent upward while avoiding the appearance of discontinuity, tearing, shearing, or other like visual interruptions.

According to one aspect, various different channels, such as the exemplary channel 331, can define the potential paths along which a virtual user input device can be bent. User movement, in virtual space, that deviates slightly from a channel, such as exemplary channel 331, can still would result in the bending of the virtual user input device 351 along the exemplary channel 331. In such a manner, minute variations in the user's movement, in virtual space, can be filtered out or otherwise ignored, and the bending of the virtual user input device 351 can proceed in a visually smooth manner. Alternatively, or in addition, user movement, in virtual space, once the user has grabbed, or otherwise interacted with, handles that provide for the bending of virtual user input devices, can be interpreted in such a way that the user movement “snaps” into existing channels, such as the exemplary channel 331. Thus, to the extent that the user movement, in virtual space, exceeds a channel, the user movement can be interpreted as still being within the channel, and the virtual user input device can be bent as if the user movement was still within the channel. Once user movement exceeds a threshold distance away from a channel, it can be reinterpreted as being within a different channel, and can, thereby appear to “snap” into that new channel. The bending of virtual user input devices can thus be limited by limiting the range of interpretation of the user's movement in virtual space.

The exemplary system 302, also shown in FIG. 3, illustrates channels for a different type of bending of the virtual user input device, such as the exemplary virtual user input device 361. In the exemplary system 302, the exemplary virtual user input device 361 can be bent around the user, such as to position a greater portion of the virtual user input device 361 an equal distance away from the user, whose position can be represented by the user anchor point 322. As can be seen, channels such as the exemplary channel 332, can define a path along which portions of the exemplary virtual user input devices 361 can be bent. The user anchor point 322 can anchor such channels, or can otherwise be utilized to define the channels. For example, the channel 332 can be defined based on an ellipse whose minor axis can be between the location, in virtual space, of the user anchor point 322 and a location of the virtual user input device 361 that is closest to the user anchor point 322, and whose major axis can be between the two ends of the virtual user input device 361 that are farthest from the user anchor point 322.

Similar channels can be defined for intermediate portions of the virtual user input device 361. For example, the exemplary system 302 shows one other such channel, in the form of the exemplary channel 339, that can define positions, in virtual space, for intermediate points of the virtual user input device 361 while the edge points of the virtual user input device 361 are bent in accordance with the positions defined by the channel 332. In such a manner, user interaction with handles protruding from the left and right of the virtual user input device 361, such as by grabbing those handles and pulling towards the user, can result in intermediate bent versions of the virtual user input device 361, as illustrated by the intermediate bent versions 362 and 363. As indicated previously, the utilization of intermediate channels can aid to avoid discontinuity in the visual appearance of the exemplary virtual user input device 361 when it is bent by the user.

Although the descriptions above have been provided within the context of a virtual keyboard, other virtual user input devices presented within a virtual-reality environment can be equally bent in the manner described in detail above. For example, pallets or other like collections of tools can be presented proximate to a representation of the user's hand, in a virtual-reality environment, or proximate to the user's hand, in an augmented-reality environment. Such a pallet can be bent around the user's hand position so that selection of individual tools can be made easier for the user. More specifically, often such pallets were displayed at an angle, and required user pointing at specific tools to select such tools. For tools located at peripheries of the pallet, the angle differentiation in a user's pointing can be slight, such that an unwanted tool may be inadvertently selected. By bending the palette around the user's hand, a greater angle of differentiation can exist between individual tools, making it easier for the user to point to an individual tool and, thereby, select it.

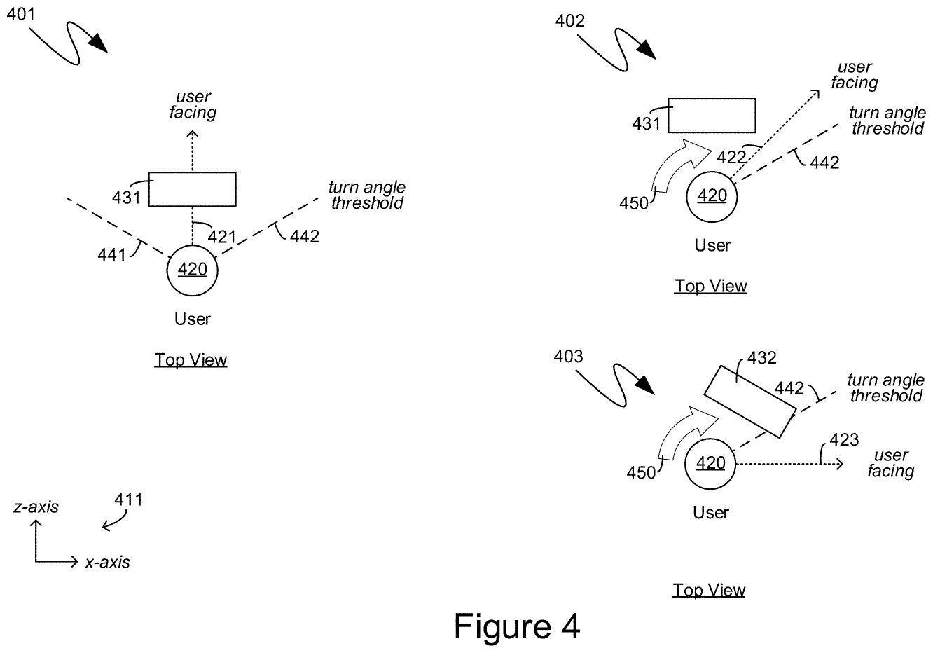

Turning to FIG. 4, an exemplary mechanism by which the virtual user input device can remain accessible to a user during user motion in virtual space is illustrated by reference to the exemplary systems 401, 402 and 403. More specifically, each of the exemplary systems 401, 402 and 403 are illustrated as if the virtual space was viewed from above, with the user's left and right being to the left and right of the page, but with the up and down direction of the page being representative of objects positioned further away, or closer to, the user in virtual space. The location of the user in virtual space is illustrated by the location 420. In the exemplary system 401, the user can have positioned a virtual user input device in front of the user, such as the exemplary virtual user input device 431. As can be seen from the exemplary system 401, the direction in which the user is facing is indicated by the arrow 421, indicating that the exemplary virtual user input device 431 is in front of the user 420 given the current direction in which the user is facing, as illustrated by the arrow 421.

According to one aspect, thresholds can be established so that some user movement does not result in the virtual user input device moving, thereby giving the appearance that the virtual user input device is fixed in virtual space, but that movement beyond the thresholds can result in the virtual user input device moving so that the user does not lose track of it in the virtual-reality environment. The exemplary system 401 illustrates turn angle thresholds 441 and 442, which can delineate a range of motion of the user 420 that either does, or does not trigger movement, within the virtual-reality environment, of the exemplary virtual user input device 431.

For example, as illustrated by the exemplary system 402, if the user turns, as illustrated by the arrow 450, such that the user is now facing in the direction illustrated by the arrow 422, the position, in virtual space, of the exemplary virtual user input device 431 can remain invariant. As a result, from the perspective of the user 420, facing the direction illustrated by the arrow 422, the exemplary virtual user input device 431 can be positioned to the user's left. Thus, as the user 420 turned in the direction 450, the exemplary virtual user input device 431 can appear to the user as if it was not moving. In such a manner, a user interacting with the exemplary virtual user input device 431 can turn to one side or the other by an amount less than the predetermined threshold without needing to readjust to the position of the exemplary virtual user input device 431. If the exemplary virtual user input device 431 was, for example, a keyboard, the user could keep their hands positioned at the same position, in virtual space, and type on the keyboard without having to adjust for the keyboard moving simply because the user adjusted their body, or the angle of their head.

However, because virtual-reality environments can lack a sufficient quantity of detail to enable a user to orient themselves, a user that turns too far in either direction me lose sight of a virtual user input device that remains at a fixed position within the virtual-reality environment. In such an instance, the user may waste time, and computer processing, turning back and forth within the virtual-reality environment trying to find the exemplary virtual user input device 431 within the virtual-reality environment. Accordingly, according to one aspect, once a user turns beyond a threshold, such as the exemplary turn angle threshold 442, the position, in virtual space, of the virtual user input device, such as the exemplary virtual user input device 431, can correspondingly change. For example, the deviation of the virtual user input device from its original position can be commensurate to the deviation beyond the turn angle threshold that the user turns. For example, as illustrated by the exemplary system 403, if the user 420 turns, as illustrated by the arrow 450, to be facing the direction represented by the arrow 423, the exemplary virtual user input device 431 can be repositioned as illustrated by the new position 432 such that the angle between the position of the exemplary virtual user input device 431, as shown in the system 402, and the position of the exemplary virtual user input device 432 can be commensurate to the difference between the turn angle threshold 442 and the current direction in which the user is facing 423. In such a manner, a virtual user input device can remain positioned to the side of the user, so that the user can quickly turn back to the virtual user input device, should the user decide to do so, without becoming disoriented irrespective of how far the user turns around within the virtual-reality environment.

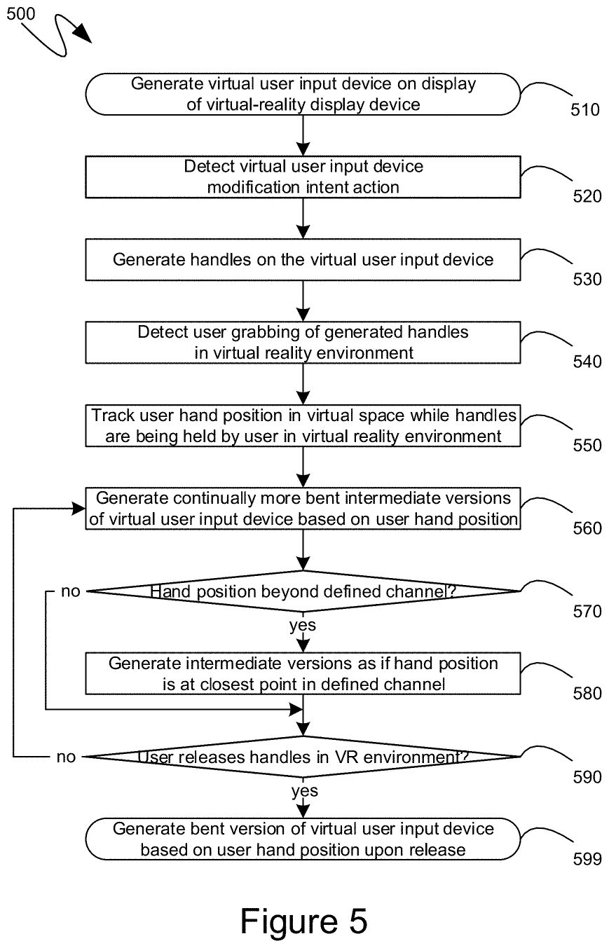

Turning to FIG. 5, the exemplary flow diagram 500 shown therein illustrates an exemplary series of steps by which a virtual user input device can be bent within the virtual-reality environment to better accommodate physical limitations of a user. Initially, at step 510, the display of a virtual user input device can be generated on one or more displays of virtual-reality display device, such as can be worn by a user to visually perceive a virtual-reality environment. Subsequently, at step 520, user action directed to the virtual user input device can be detected that evidences an intent by the user to modify the physical shape of the user input device. As indicated previously, such action can include the user interacting with an edge, corner, or other like extremity of the virtual user input device, the user directing the focus of their view onto the virtual user input device for greater than a threshold amount of time without physically interacting with the virtual user input device, the user selecting a particular command or input on a physical user input device, or combinations thereof. Upon the detection of such a modification intent action, at step 520, processing can proceed to step 530 and virtual handles can be generated on the display of the virtual-reality display device to appear to a user wearing the virtual-reality display device as if the virtual handles were protruding, or were otherwise visually associated with the virtual user input device in the virtual-reality environment. According to one aspect, rather than conditioning the generation of the virtual handles, at step 530, upon the predecessor step of detecting an appropriate modification intent action at step 520, the virtual handles can be always displayed.

At step 540, a user action, within the virtual environment, directed to the handles generated at step 530, can be detected. Such a user action can be a grab action, a touch action, or some other form of selection action. Once the user has grabbed, or otherwise interacted with the handles generated at step 530, as detected at step 540, processing can proceed to step 550, and the position of the user's hands within the virtual space can be tracked while the user continues to interact, such as by continuing to grab, the handles. At step 560, continually more bent versions of the virtual user input device can be generated based on a current position of the user's hands while they continue to interact with the handles. As indicated previously, bent versions of the virtual user input device can be generated based upon the position of the user's hands in the virtual space, as tracked at step 550, in combination with previously established channels or other like guides for the bending of virtual user input devices. At step 570, for example, a determination can be made as to whether the user's hand position has traveled beyond a defined channel. As detailed previously, user hand position can be “snapped to” predetermined channels. Consequently, to implement such a “snapping to” effect in the virtual space, intermediate versions of the bent virtual user input devices being generated at step 560 can be generated as if the user's hand position is at the closest point within the defined channel to the actual position of the user's hands, in virtual space, if, at step 570, the position, in virtual space, of the user's hands is beyond defined channels. Such a generation of intermediate bent versions of the virtual user input devices can be performed at step 580. Conversely, if, at step 570, the position of the user's hands, in virtual space, has not gone beyond a defined channel, then processing can proceed to step 590, and a determination can be made as to whether the user has released, or otherwise stopped interacting with, the handles. If, at step 590, it is determined that the user has not yet released, or stopped interacting with, the handles, then processing can return to step 560. Conversely, if, at step 590 it is determined that the user has released, or has otherwise stopped interacting with, the handles, then a final bent version of the virtual user input device can be generated based upon the position, in virtual space, of the user's hands at the time that the user stopped interacting with the handles. Such a final bent version of the virtual user input device can be generated at step 599.

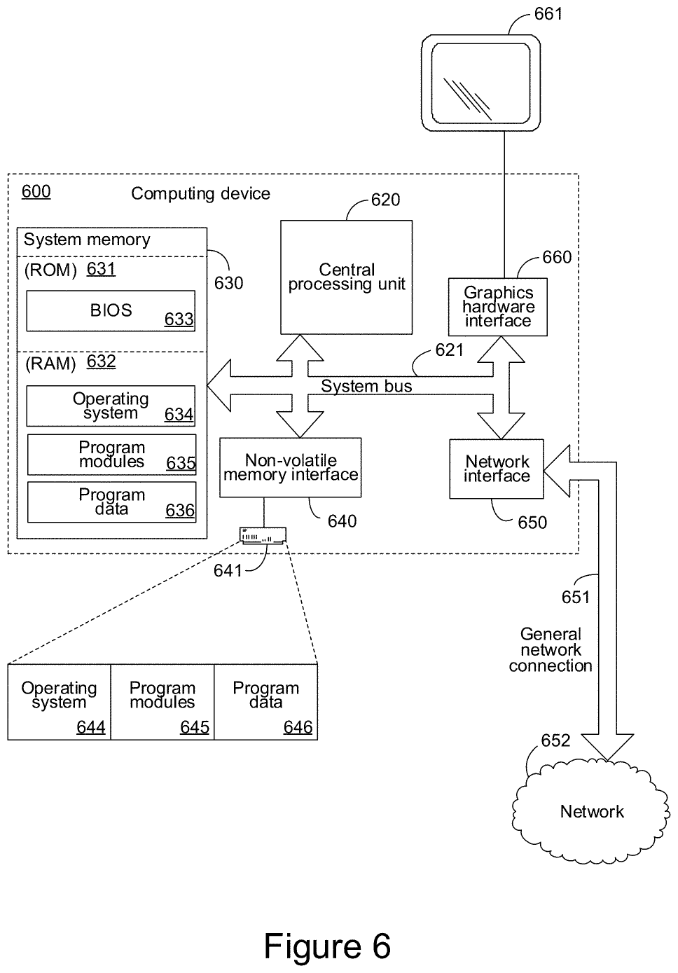

Turning to FIG. 6, an exemplary computing device 600 is illustrated which can perform some or all of the mechanisms and actions described above. The exemplary computing device 600 can include, but is not limited to, one or more central processing units (CPUs) 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. The computing device 600 can optionally include graphics hardware, including, but not limited to, a graphics hardware interface 660 and a display device 661, which can include display devices capable of receiving touch-based user input, such as a touch-sensitive, or multi-touch capable, display device. The display device 661 can further include a virtual-reality display device, which can be a virtual-reality headset, a mixed reality headset, an augmented reality headset, and other like virtual-reality display devices. As will be recognized by those skilled in the art, such virtual-reality display devices comprise either two physically separate displays, such as LCD displays, OLED displays or other like displays, where each physically separate display generates an image presented to a single one of a user's two eyes, or they comprise a single display device associated with lenses or other like visual hardware that divides the display area of such a single display device into areas such that, again, each single one of the user's two eyes receives a slightly different generated image. The differences between such generated images are then interpreted by the user's brain to result in what appears, to the user, to be a fully three-dimensional environment.

Returning to FIG. 6, depending on the specific physical implementation, one or more of the CPUs 620, the system memory 630 and other components of the computing device 600 can be physically co-located, such as on a single chip. In such a case, some or all of the system bus 621 can be nothing more than silicon pathways within a single chip structure and its illustration in FIG. 6 can be nothing more than notational convenience for the purpose of illustration.

The computing device 600 also typically includes computer readable media, which can include any available media that can be accessed by computing device 600 and includes both volatile and nonvolatile media and removable and non-removable media. By way of example, and not limitation, computer readable media may comprise computer storage media and communication media. Computer storage media includes media implemented in any method or technology for storage of content such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired content and which can be accessed by the computing device 600. Computer storage media, however, does not include communication media. Communication media typically embodies computer readable instructions, data structures, program modules or other data in a modulated data signal such as a carrier wave or other transport mechanism and includes any content delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer content between elements within computing device 600, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, other program modules 635, and program data 636.

The computing device 600 may also include other removable/non-removable, volatile/nonvolatile computer storage media. By way of example only, FIG. 6 illustrates a hard disk drive 641 that reads from or writes to non-removable, nonvolatile magnetic media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and other computer storage media as defined and delineated above. The hard disk drive 641 is typically connected to the system bus 621 through a non-volatile memory interface such as interface 640.

The drives and their associated computer storage media discussed above and illustrated in FIG. 6, provide storage of computer readable instructions, data structures, program modules and other data for the computing device 600. In FIG. 6, for example, hard disk drive 641 is illustrated as storing operating system 644, other program modules 645, and program data 646. Note that these components can either be the same as or different from operating system 634, other program modules 635 and program data 636. Operating system 644, other program modules 645 and program data 646 are given different numbers hereto illustrate that, at a minimum, they are different copies.

The computing device 600 may operate in a networked environment using logical connections to one or more remote computers. The computing device 600 is illustrated as being connected to the general network connection 651 (to the network 190) through a network interface or adapter 650, which is, in turn, connected to the system bus 621. In a networked environment, program modules depicted relative to the computing device 600, or portions or peripherals thereof, may be stored in the memory of one or more other computing devices that are communicatively coupled to the computing device 600 through the general network connection 651. It will be appreciated that the network connections shown are exemplary and other means of establishing a communications link between computing devices may be used.

Although described as a single physical device, the exemplary computing device 600 can be a virtual computing device, in which case the functionality of the above-described physical components, such as the CPU 620, the system memory 630, the network interface 640, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where the exemplary computing device 600 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. The term “computing device”, therefore, as utilized herein, means either a physical computing device or a virtualized computing environment, including a virtual computing device, within which computer-executable instructions can be executed in a manner consistent with their execution by a physical computing device. Similarly, terms referring to physical components of the computing device, as utilized herein, mean either those physical components or virtualizations thereof performing the same or equivalent functions.

The descriptions above include, as a first example one or more computer-readable storage media comprising computer-executable instructions, which, when executed by one or more processing units of one or more computing devices, cause the one or more computing devices to: generate, on a display of a virtual-reality display device, a virtual user input device having a first appearance, when viewed through the virtual-reality display device, within a virtual-reality environment; detect a first user action, in the virtual-reality environment, the first user action utilizing the virtual user input device to enter a first user input; detect a second user action, in the virtual-reality environment, the second user action directed to modifying an appearance of the virtual user input device in the virtual-reality environment; and generate, on the display, in response to the detection of the second user action, a bent version of the virtual user input device, the bent version of the virtual user input device having a second appearance, when viewed through the virtual-reality display device, within the virtual-reality environment; wherein user utilization of the virtual user input device in the virtual-reality environment to enter user input requires a first range of physical motion of a user when the virtual user input device has the first appearance and a second, different, range of physical motion of the user when the virtual user input device has the second appearance.

A second example is the computer-readable storage media of the first example, wherein the bent version of the virtual user input device is bent along a predefined bend path anchored by a position of the user relative to a position of the virtual user input device in the virtual-reality environment.

A third example is the computer-readable storage media of the first example, wherein the bent version of the virtual user input device is bent to a maximum bend amount corresponding to a bending user action threshold even if the detected second user action exceeds the bending user action threshold.

A fourth example is the computer-readable storage media of the first example, wherein the first range of motion exceeds a user's range of motion without moving their feet while the second range of motion is encompassed by the user's range of motion without moving their feet.

A fifth example is the computer-readable storage media of the first example, wherein the first appearance comprises the virtual user input device positioned in front of the user in the virtual-reality environment and the second appearance comprises the virtual user input device bent at least partially around the user in the virtual-reality environment.

A sixth example is the computer-readable storage media of the first example, wherein the first appearance comprises the virtual user input device positioned horizontally extending away from the user in the virtual-reality environment and the second appearance comprises the virtual user input device bent vertically upward in the virtual-reality environment with a first portion of the virtual user input device that is further from the user in the virtual-reality environment being higher than a second portion of the virtual user input device that is closer to the user in the virtual-reality environment.

A seventh example is the computer-readable storage media of the first example, wherein the computer-executable instructions for generating the bent version of the virtual user input device comprise computer-executable instructions which, when executed by the one or more processing units of the one or more computing devices, cause the one or more computing devices to: generate, on the display, as part of the generating the bent version of the virtual user input device, skewed or bent versions of multiple ones of individual virtual user input element of the virtual user input device, each of the multiple ones of the individual virtual user input elements being skewed or bent in accordance with their position on the virtual user input device.

An eighth example is the computer-readable storage media of the first example, wherein the virtual user input device is a virtual alphanumeric keyboard.

A ninth example is the computer-readable storage media of the first example, wherein the virtual user input device is a virtual tool palette that floats proximate to a user's hand in the virtual-reality environment, the bent version of the virtual user input device comprising the virtual tool palette being bent around the user's hand in the virtual-reality environment.

A tenth example is the computer-readable storage media of the first example, comprising further computer-executable instructions which, when executed by the one or more processing units of the one or more computing devices, cause the one or more computing devices to: detect the user turning from an initial position to a first position; and generate, on the display, in response to the detection of the user turning, the virtual user input device in a new position in the virtual-reality environment; wherein the generating the virtual user input device in the new position is only performed if an angle between the initial position of the user and the first position of the user is greater than a threshold angle.

An eleventh example is the computer-readable storage media of the tenth example, wherein the new position of the virtual user input device is in front of the user when the user is in the first position.

A twelfth example is the computer-readable storage media of the tenth example, wherein the new position of the virtual user input device is to a side of the user in the virtual-reality environment at an angle corresponding to the threshold angle.

A thirteenth example is the computer-readable storage media of the first example, wherein the second user action comprises the user grabbing and moving one or more handles protruding from the virtual user input device in the virtual-reality environment.

A fourteenth example is the computer-readable storage media of the thirteenth example, comprising further computer-executable instructions which, when executed by the one or more processing units of the one or more computing devices, cause the one or more computing devices to: generate, on the display, the one or more handles only if a virtual user input device modification intent action is detected, the virtual user input device modification intent action being one of: the user looking at the virtual user input device in the virtual-reality environment for an extended period of time or the user reaching for an edge of the virtual user input device in the virtual-reality environment.

A fifteenth example is a method of reducing physical strain on a user utilizing a virtual user input device in a virtual-reality environment, the user perceiving the virtual-reality environment at least in part through a virtual-reality display device comprising at least one display, the method comprising: generating, on the at least one display of the virtual-reality display device, the virtual user input device having a first appearance, when viewed through the virtual-reality display device, within the virtual-reality environment; detecting a first user action, in the virtual-reality environment, the first user action utilizing the virtual user input device to enter a first user input; detecting a second user action, in the virtual-reality environment, the second user action directed to modifying an appearance of the virtual user input device in the virtual-reality environment; and generating, on the at least one display, in response to the detection of the second user action, a bent version of the virtual user input device, the bent version of the virtual user input device having a second appearance, when viewed through the virtual-reality display device, within the virtual-reality environment; wherein user utilization of the virtual user input device in the virtual-reality environment to enter user input requires a first range of physical motion of a user when the virtual user input device has the first appearance and a second, different, range of physical motion of the user when the virtual user input device has the second appearance.

A sixteenth example is the method of the fifteenth example, wherein the bent version of the virtual user input device is bent along a predefined bend path anchored by a position of the user relative to a position of the virtual user input device in the virtual-reality environment.

A seventeenth example is the method of the fifteenth example, further comprising: generating, on the at least one display, as part of the generating the bent version of the virtual user input device, skewed or bent versions of multiple ones of individual virtual user input element of the virtual user input device, each of the multiple ones of the individual virtual user input elements being skewed or bent in accordance with their position on the virtual user input device.

An eighteenth example is the method of the fifteenth example, further comprising: detecting the user turning from an initial position to a first position; and generating, on the at least one display, in response to the detection of the user turning, the virtual user input device in a new position in the virtual-reality environment; wherein the generating the virtual user input device in the new position is only performed if an angle between the initial position of the user and the first position of the user is greater than a threshold angle.

A nineteenth example is the method of the fifteenth example, wherein the second user action comprises the user grabbing and moving one or more handles protruding from the virtual user input device in the virtual-reality environment.

A twentieth example is a computing device communicationally coupled to a virtual-reality display device comprising at least one display, the computing device comprising: one or more processing units; and one or more computer-readable media comprising computer-executable instructions, which, when executed by the one or more processing units, cause the computing device to: generate, on the at least one display of the virtual-reality display device, a virtual user input device having a first appearance, when viewed through the virtual-reality display device, within a virtual-reality environment; detect a first user action, in the virtual-reality environment, the first user action utilizing the virtual user input device to enter a first user input; detect a second user action, in the virtual-reality environment, the second user action directed to modifying an appearance of the virtual user input device in the virtual-reality environment; and generate, on the at least one display, in response to the detection of the second user action, a bent version of the virtual user input device, the bent version of the virtual user input device having a second appearance, when viewed through the virtual-reality display device, within the virtual-reality environment; wherein user utilization of the virtual user input device in the virtual-reality environment to enter user input requires a first range of physical motion of a user when the virtual user input device has the first appearance and a second, different, range of physical motion of the user when the virtual user input device has the second appearance.

As can be seen from the above descriptions, mechanisms for generating bent versions of virtual user input devices to accommodate physical user limitations have been presented. In view of the many possible variations of the subject matter described herein, we claim as our invention all such embodiments as may come within the scope of the following claims and equivalents thereto.

1. One or more computer-readable storage media comprising computer-executable instructions, which, when executed by one or more processing units of one or more computing devices, cause the one or more computing devices to:
generate, on a display of a virtual-reality display device, a virtual user input device having a first appearance, when viewed through the virtual-reality display device, within a virtual-reality environment;
detect a first user action, in the virtual-reality environment, the first user action utilizing the virtual user input device to enter a first user input;
detect a second user action, in the virtual-reality environment, the second user action directed to modifying an appearance of the virtual user input device in the virtual-reality environment; and
generate, on the display, in response to the detection of the second user action, a bent version of the virtual user input device, the bent version of the virtual user input device having a second appearance, when viewed through the virtual-reality display device, within the virtual-reality environment;
wherein user utilization of the virtual user input device in the virtual-reality environment to enter user input requires a first range of physical motion of a user when the virtual user input device has the first appearance and a second, different, range of physical motion of the user when the virtual user input device has the second appearance.

2. The computer-readable storage media of claim 1, wherein the bent version of the virtual user input device is bent along a predefined bend path anchored by a position of the user relative to a position of the virtual user input device in the virtual-reality environment.

3. The computer-readable storage media of claim 1, wherein the bent version of the virtual user input device is bent to a maximum bend amount corresponding to a bending user action threshold even if the detected second user action exceeds the bending user action threshold.

4. The computer-readable storage media of claim 1, wherein the first range of motion exceeds a user's range of motion without moving their feet while the second range of motion is encompassed by the user's range of motion without moving their feet.

5. The computer-readable storage media of claim 1, wherein the first appearance comprises the virtual user input device positioned in front of the user in the virtual-reality environment and the second appearance comprises the virtual user input device bent at least partially around the user in the virtual-reality environment.

6. The computer-readable storage media of claim 1, wherein the first appearance comprises the virtual user input device positioned horizontally extending away from the user in the virtual-reality environment and the second appearance comprises the virtual user input device bent vertically upward in the virtual-reality environment with a first portion of the virtual user input device that is further from the user in the virtual-reality environment being higher than a second portion of the virtual user input device that is closer to the user in the virtual-reality environment.

7. The computer-readable storage media of claim 1, wherein the computer-executable instructions for generating the bent version of the virtual user input device comprise computer-executable instructions which, when executed by the one or more processing units of the one or more computing devices, cause the one or more computing devices to:
generate, on the display, as part of the generating the bent version of the virtual user input device, skewed or bent versions of multiple ones of individual virtual user input element of the virtual user input device, each of the multiple ones of the individual virtual user input elements being skewed or bent in accordance with their position on the virtual user input device.

8. The computer-readable storage media of claim 1, wherein the virtual user input device is a virtual alphanumeric keyboard.

9. The computer-readable storage media of claim 1, wherein the virtual user input device is a virtual tool palette that floats proximate to a user's hand in the virtual-reality environment, the bent version of the virtual user input device comprising the virtual tool palette being bent around the user's hand in the virtual-reality environment.

10. The computer-readable storage media of claim 1, comprising further computer-executable instructions which, when executed by the one or more processing units of the one or more computing devices, cause the one or more computing devices to:
detect the user turning from an initial position to a first position; and
generate, on the display, in response to the detection of the user turning, the virtual user input device in a new position in the virtual-reality environment;
wherein the generating the virtual user input device in the new position is only performed if an angle between the initial position of the user and the first position of the user is greater than a threshold angle.

11. The computer-readable storage media of claim 10, wherein the new position of the virtual user input device is in front of the user when the user is in the first position.

12. The computer-readable storage media of claim 10, wherein the new position of the virtual user input device is to a side of the user in the virtual-reality environment at an angle corresponding to the threshold angle.

13. The computer-readable storage media of claim 1, wherein the second user action comprises the user grabbing and moving one or more handles protruding from the virtual user input device in the virtual-reality environment.

14. The computer-readable storage media of claim 13, comprising further computer-executable instructions which, when executed by the one or more processing units of the one or more computing devices, cause the one or more computing devices to:
generate, on the display, the one or more handles only if a virtual user input device modification intent action is detected, the virtual user input device modification intent action being one of: the user looking at the virtual user input device in the virtual-reality environment for an extended period of time or the user reaching for an edge of the virtual user input device in the virtual-reality environment.

15. A method of reducing physical strain on a user utilizing a virtual user input device in a virtual-reality environment, the user perceiving the virtual-reality environment at least in part through a virtual-reality display device comprising at least one display, the method comprising:
generating, on the at least one display of the virtual-reality display device, the virtual user input device having a first appearance, when viewed through the virtual-reality display device, within the virtual-reality environment;
detecting a first user action, in the virtual-reality environment, the first user action utilizing the virtual user input device to enter a first user input;
detecting a second user action, in the virtual-reality environment, the second user action directed to modifying an appearance of the virtual user input device in the virtual-reality environment; and
generating, on the at least one display, in response to the detection of the second user action, a bent version of the virtual user input device, the bent version of the virtual user input device having a second appearance, when viewed through the virtual-reality display device, within the virtual-reality environment;
wherein user utilization of the virtual user input device in the virtual-reality environment to enter user input requires a first range of physical motion of a user when the virtual user input device has the first appearance and a second, different, range of physical motion of the user when the virtual user input device has the second appearance.

16. The method of claim 15, wherein the bent version of the virtual user input device is bent along a predefined bend path anchored by a position of the user relative to a position of the virtual user input device in the virtual-reality environment.

17. The method of claim 15, further comprising:
generating, on the at least one display, as part of the generating the bent version of the virtual user input device, skewed or bent versions of multiple ones of individual virtual user input element of the virtual user input device, each of the multiple ones of the individual virtual user input elements being skewed or bent in accordance with their position on the virtual user input device.

18. The method of claim 15, further comprising:
detecting the user turning from an initial position to a first position; and
generating, on the at least one display, in response to the detection of the user turning, the virtual user input device in a new position in the virtual-reality environment;
wherein the generating the virtual user input device in the new position is only performed if an angle between the initial position of the user and the first position of the user is greater than a threshold angle.

19. The method of claim 15, wherein the second user action comprises the user grabbing and moving one or more handles protruding from the virtual user input device in the virtual-reality environment.

20. A computing device communicationally coupled to a virtual-reality display device comprising at least one display, the computing device comprising:
one or more processing units; and
one or more computer-readable media comprising computer-executable instructions, which, when executed by the one or more processing units, cause the computing device to:
generate, on the at least one display of the virtual-reality display device, a virtual user input device having a first appearance, when viewed through the virtual-reality display device, within a virtual-reality environment;
detect a first user action, in the virtual-reality environment, the first user action utilizing the virtual user input device to enter a first user input;
detect a second user action, in the virtual-reality environment, the second user action directed to modifying an appearance of the virtual user input device in the virtual-reality environment; and
generate, on the at least one display, in response to the detection of the second user action, a bent version of the virtual user input device, the bent version of the virtual user input device having a second appearance, when viewed through the virtual-reality display device, within the virtual-reality environment;
wherein user utilization of the virtual user input device in the virtual-reality environment to enter user input requires a first range of physical motion of a user when the virtual user input device has the first appearance and a second, different, range of physical motion of the user when the virtual user input device has the second appearance.
